(19) United States
(12) Patent Application Publication
(10) Pub. No.: US 2004/0132857 A1
(43) Pub. Date: Jul. 8, 2004

(54) Curable covercoat compositions, cured products obtained therefrom, and methods of manufacture thereof

(76) Inventors: Carlos L. Barton, Brooklyn, CT (US); Seung B. Chun, Pomfret Center, CT (US)

Correspondence Address: CANTOR COLBURN, LLP, 55 GRIFFIN ROAD SOUTH, BLOOMFIELD, CT, 06002

(21) Appl. No.: 10/723,440

(22) Filed: Nov. 25, 2003

Related U.S. Application Data
(60) Provisional application No. 60/429,033, filed on Nov. 25, 2002.

(51) Int. Cl. C08F 2/46

(52) U.S. Cl. 522/168

(57) ABSTRACT

A curable covercoat composition comprises an esterified styrene maleic anhydride oligomer, wherein the ester groups comprise an acrylate group, a methacrylate group, or both, a photoinitiator composition, and a curing agent. The curable covercoat composition may comprise a two-part composition, in which the two parts are mixed prior to use. The two parts may be stored separately to ensure that the product has a long shelf life. Furthermore, the two parts may be mixed in different ratios to obtain a cured covercoat that can be used in printed circuit boards in a wide variety of commercial applications, where reduced shrinkage, increased flexibility, and long life are desired.

### CROSS REFERENCE TO RELATED APPLICATION

This application claims the benefits of U.S. Provisional Patent Application Serial No. 60/429,033 filed Nov. 25, 2002, the entire contents of which is incorporated herein by reference.

### BACKGROUND

This disclosure relates generally to curable covercoat compositions, cured products obtained from the curable covercoat compositions and methods of manufacture thereof.

In recent years, the increase in demand for consumer electronic goods and computers has led to a corresponding increase in the demand for photoimageable inks or covercoats for use in printed circuit boards. These photoimageable inks or covercoats are typically ultraviolet (UV) cured or heat cured compositions, which may be applied to the circuit board to be printed and then cured using UV radiation or heat. For example, U.S. Pat. No. 5,702,820 to Yokoshima et al. discloses a photoimageable ink containing a photopolymerization initiator, a curing component and a polycarboxylic acid resin having an unsaturated group. The polycarboxylic acid resin is reacted with a curing component such as an epoxy compound using heat or UV light to form a photo resist or solder resist for a printed circuit board. Similarly, U.S. Pat. No. 5,009,982 to Kamayachi et al. discloses a photosetting, thermosetting ink, which comprises an initiator, a diluent and a polybasic acid anhydride that is the reaction product of a novolak epoxy compound with an unsaturated monocarboxylic acid.

While some of the commercially available photo imageable covercoats are useful in a variety of electronic applications, they suffer from several drawbacks that limit their applicability. Chief among these drawbacks is the brittleness of the cured ink, which reduces the useful lifetime of the application and does not permit use with flexible printed circuit boards. Another drawback is the shrinkage that may occur during curing, which reduces the flatness of the circuitry. There accordingly remains a need for photoimageable inks that are less brittle, have greater ductility, and have reduced shrinkage during curing. Such inks can provide electronic goods and other articles such as computers with a longer useful life span.

### SUMMARY

The above-described drawbacks and disadvantages are alleviated by a curable covercoat composition comprising about 5 to about 95 weight % of an esterified styrene maleic anhydride oligomer, wherein the ester group comprises an acrylate functionality, a methacrylate functionality, or both; about 0.02 to about 16 weight % of a photoinitiator composition; and about 1 to about 50 weight % of a curing agent; wherein all amounts are based on the total weight of the curable covercoat composition.

A method of forming a cured covercoat comprises coating an object with the curable covercoat composition; and curing the film using a source of radiation.

The curable covercoat composition may comprise a two-part composition, wherein the two parts are mixed prior to use. The two parts may be stored separately to ensure that the product has a long shelf life. Furthermore, the two parts may be mixed in different ratios to obtain a cured covercoat that can be used in printed circuit boards in a wide variety of commercial applications, where reduced shrinkage, increased flexibility, and long life are desired.

### DETAILED DESCRIPTION OF PREFERRED EMBODIMENTS

A curable covercoat composition comprises an esterified styrene maleic anhydride oligomer, a photoinitiator and a curing agent. It has been unexpectedly discovered that when cured, the covercoat has improved flexibility (i.e., reduced brittleness) and reduced shrinkage as compared to similar commercially available covercoats. Another advantage is that because of the relative transparency of the oligomers at the wavelengths used to activate the photoinitiator, the oligomers do not absorb a significant portion of the UV radiation. Thus, the curing reaction is more efficient. Because less UV energy is required for curing, a lower dosage of UV radiation may be used. In a practical sense, the lower amount of UV radiation means that production of the coatings can proceed at a faster rate.

The esterified styrene maleic anhydride oligomer utilized in the curable covercoat composition is a styrene maleic anhydride oligomer that has been modified by reaction with a hydroxyacrylate or hydroxymethacrylate to yield a reactive oligomer having a carboxyl functionality and an acrylate or methacrylate functionality. The carboxyl functionalities provide alkaline aqueous solubility, while the acrylate or methacrylate functionalities allow for photochemically induced crosslinking. Both of these functionalities are desirable for making curable covercoat compositions that are water soluble and can exist in the form of an aqueous solution, prior to use as a cured covercoat.

The styrene maleic anhydride oligomer of Formula I below may be obtained by a reaction between styrene and maleic anhydride.

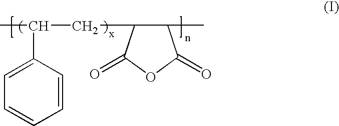

wherein n is 2 to about 20, preferably about 8 to about 12, and x is 1 to 4. The styrene maleic anhydride oligomer utilized in the curable covercoat compositions may have a styrene to maleic anhydride molar ratio of about 1:4 to about 4:1. It is preferable to have a styrene to maleic anhydride molar ratio of about 1:2 to about 2:1, more preferably about 1:1.5 to about 1.5:1, and most preferable to have a styrene to maleic anhydride molar ratio of about 1:1.

The styrene maleic anhydride oligomers may have glass transition temperatures of about 115° C. to about 155° C. In addition, it is preferable to use styrene maleic anhydride oligomers having a volatiles content less than or equal to about 5 weight % (wt %), preferably less than or equal to about 3 wt %, and most preferably less than or equal to about 1 wt % of the total weight of the styrene maleic anhydride oligomer.

As stated above, the styrene maleic anhydride oligomer of formula (I) may be reacted with a hydroxyacrylate or hydroxymethacrylate to yield an esterified styrene maleic anhydride oligomer having carboxyl functionalities and acrylate or methacrylate functionalities as shown in Formula (II)

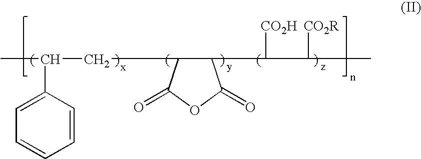

wherein n is about 2 to about 20; x is about 1 to about 4; the molar ratio of x:(y+z) is about 4:1 to about 1:4, preferably about 2:1 to about 1:2; y is preferably about 0.1 to about 0.9, z is preferably about 0.1 to about 0.9, wherein (y+z) is 1; and R is a moiety containing an acrylate functionality, a methacrylate functionality, or both, and preferably R is a monovalent moiety derived from an acrylate or methacrylate having at least one group reactive with an anhydride, preferably a hydroxyacrylate or hydroxymethacrylate.

Suitable examples of hydroxyacrylates or hydroxymethacrylates that may be utilized for reaction with the styrene maleic anhydride oligomer include hydroxyethyl acrylate, hydroxyethyl methacrylate, hydroxypropyl acrylate, hydroxypropyl methacrylate, hydroxybutyl acrylate, hydroxybutyl methacrylate, polyethylene glycol monoacrylate, polyethylene glycol monomethacrylate, glycerol diacrylate, glycerol dimethacrylate, trimethylolpropane diacrylate, trimethylolpropane dimethacrylate pentaerythritol triacrylate, pentaerythritol trimethacrylate, dipentaerythritol pentaacrylate, dipentaerythritol pentalnethacrylate, the acrylate of phenyl glycidyl ether, the methacrylate of phenyl glycidyl ether, and combinations comprising at least one of the foregoing acrylates.

The esterified styrene maleic anhydride oligomers of Formula II generally have glass transition temperatures of about 60° C. to about 125° C., with acid numbers of about 95 meq/kg to about 300 meq/kg. It is generally desirable to use esterified styrene maleic anhydride oligomers having a volatiles content less than or equal to about 8 wt %, preferably less than or equal to about 6 wt %, and most preferably less than or equal to about 5 wt %, based on the total weight of the esterified styrene maleic anhydride oligomer. The molecular weight of the esterified styrene maleic anhydride oligomer may be greater than or equal to about 1,000 grams/mole, preferably greater than or equal to about 2,000 grams/mole. It is generally desirable to use esterified styrene maleic anhydride oligomers having a molecular weight less than or equal to about 15,000 grams/mole, preferably less than or equal to about 13,000 grams/mole, and most preferably less than or equal to about 11,000 grams/mole as determined by gel permeation chromatography (GPC). The most preferred esterified styrene maleic anhydride oligomers are those wherein x is about 1 to about 2, y is about 0.1 to about 0.5, z is about 0.5 to about 0.9, and (y+z)=about 1; more preferably, x is about 1 and (y+z) is about 1. A particularly suitable oligomer is commercially available as SB405® (SARBOX 405) from Sartomer.

The esterified styrene maleic anhydride oligomers may be present in the curable covercoat composition in an amount of greater than or equal to about 5 wt %, preferably greater than or equal to about 7 wt %, and more preferably greater than or equal to about 10 wt %, based on the total weight of the curable covercoat composition. The esterified styrene maleic anhydride oligomers may also be present in the curable covercoat composition in an amount of less than or equal to about 99 wt %, preferably less than or equal to about 95 wt %, and more preferably less than or equal to about 90 wt %, based on the total weight of the curable covercoat composition.

The photoinitiator composition in the curable covercoat composition comprises a photoinitiator that is capable of initiating polymerization in cooperation with light. Suitable examples of such photoinitiators include, but are not limited to, benzoins such as benzoin, benzoin methyl ether, and benzoin isopropyl ether; acetophenones such as acetophenone, 2,2-dimethoxy-2-phenylacetophenone, 2,2-diethoxy-2-phenylacetophenone, 1,1-dichloroacetophenone, 1-hydroxycyclohexyl phenyl ketone, and N,N-dimethylaminoacetophenone; anthraquinones such as 2-methylanthraquinone, 2-ethylanthraquinone, 2-tert-butylanthraquinone, 1-chloroanthraquinone, 2-amylanthraquinone, and 2-aminoanthraquinone; thioxanthones such as 2,4-dimethylthioxanthone, 2,4-diethylthioxanthone, 2-chlorothioxanthone, and 2,4-diisopropylthioxanthone; morpholino derivatives such as methyl-1-[4-(methylthio phenyl)-2-morpholine propane-1-one; ketals such as acetophenone dimethyl ketal and benzyl dimethyl ketal; benzophenones such as benzophenone, methylbenzophenone, 4,4′-dichlorobenzophenone, 4,4′-bis-diethylaminobenzophenone; and others, such as Michler's ketone, 4-benzoyl-4′-methyldiphenyl sulfide; acylphosphine oxide, 2,4,6-trimethylbenzoyldiphenylphosphine oxide, and combinations comprising at least one of the foregoing photoinitiators.

The photoinitiator may be present in the curable covercoat composition in an amount of greater than or equal to about 0.01 wt %, preferably greater than or equal to about 0.1 wt %, and more preferably greater than or equal to about 1 wt %, based on the total weight of the curable covercoat composition. The photoinitiator may also be present in the curable covercoat composition in an amount of less than or equal to about 8 wt %, preferably less than or equal to about 5 wt %, and more preferably less than or equal to about 3 wt %, based on the total weight of the curable covercoat composition.

In addition to the photoinitiator, the photoinitiator composition may also contain additional components such as photosensitizers (e.g., tertiary amines such as ethyl N,N-dimethylaminobenzoate, isoamyl N,N-dimethylaminobenzoate, pentyl 4-dimethylaminobenzoate, triethylamine, and triethanolamine), UV absorbers (e.g., benzophenones such as 4,4-bis(diethylamino)benzophenone, and benzotriazoles), stabilizers, and the like, and combinations comprising at least one of the foregoing components, in amounts effective to impart desirable properties to the cured covercoat depending on the application at hand. The photosensitizer may be present in curable covercoat composition in an amount of greater than or equal to about 0.01 wt %, preferably greater than or equal to about 0.1 wt %, and more preferably greater than or equal to about 1 wt %, based on the total weight of the curable covercoat composition. The photosensitizer may also be present in the curable covercoat composition in an amount of less than or equal to about 8 wt %, preferably less than or equal to about 5 wt %, and more preferably less than or equal to about 3 wt %, based on the total weight of the curable covercoat composition.

The curing agent in the curable covercoat composition is preferably one that can be cured by the application of heat or UV radiation. The curing agent may be utilized to improve cured cover coat properties such as adhesion, heat resistance, and/or plating resistance. Specific non-limiting examples of the curing agent include melamine compounds, urea compounds, bisphenol A compounds, glycoluril compounds, diamine compounds, triazines such as benzoguanamines, oxazoline compounds, and combinations comprising at least one of the foregoing curing agents. As used herein, a “melamine compound,” for example, is inclusive of melamine itself and melamine derivatives suitable for use as a curing agent in the present covercoat compositions. Suitable examples of the melamine compounds include hexamethoxymelamine (alkylated melamine formaldehyde resin), hexabutoxylated melamine, and condensed hexamethoxymelamine, while a suitable example of a urea compound is dimethylol urea. Similarly, a suitable example of a bisphenol A compound is tetramethylol bisphenol A. It may also be desirable to use a combination of different curing agents in the covercoat composition. A preferred curing agent is hexamethoxymelamine (alkylated melamine formaldehyde resin) commercially available from Cytec under the tradename CYMEL 300 resin.

In one embodiment, the curing agent is a glycoluril prepared by reacting two moles of urea with one mole of glyoxal, as described in U.S. Pat. Nos. 4,064,191 and 4,105,708 to American Cyanamid. Tetramethoxymethyl glycoluril may be produced by reaction of glycoluril with about 4 moles of formaldehyde, followed by alkylation with methanol.

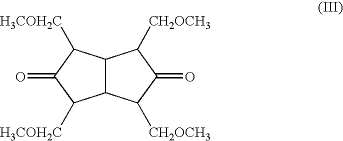

A preferred glycoluril curing agent is tetramethoxymethyl glycoluril shown above in Formula (III), commercially available as POWDERLINK 1174 from Cytec.

The curing agent may be used in the curable covercoat composition in an amount of greater than or equal to about 1 wt %, preferably greater than or equal to about 2 wt %, and more preferably greater than or equal to about 3 wt %, based on the total weight of the curable covercoat composition. The curing agent may also be present in the curable covercoat composition in an amount of less than or equal to about 50 wt %, preferably less than or equal to about 25 wt %, and more preferably less than or equal to about 20 wt %, based on the total weight of the curable covercoat composition.

A number of optional components may further be added to the curable covercoat composition in order to provide certain desirable properties to the cured covercoat. These optional components include, but are not limited to, accelerators, solvents, detackifying agents, inorganic fillers, and the like, and combinations comprising at least one of the foregoing components.

Accelerators may optionally be utilized in the curable covercoat compositions in order to accelerate a thermal cure reaction. When accelerators are employed, the thermal temperature utilized for the curing reaction is lowered. Suitable accelerators are strong acids such as hydrofluoric acid, triflic acid, p-toluene sulfonic acid and sulfuric acid, which may react with amines present to give salts, but do not form insoluble species. Suitable commercially available accelerators are CYCAT 4040, CYCAT 600, and POWDERLINK MTSI a substituted acrylamide catalyst, all supplied by Cytec Corporation located in West Patterson, N.J. An accelerator, if present, may be used in the curable covercoat composition in an amount of up to about 5 wt %, preferable greater than or equal to about 0.2 wt %, more preferably greater than or equal to about 0.5 wt %, and most preferably greater than or equal to about 0.8 wt %, based on the total weight of the curable covercoat composition. The accelerator may also be present in the curable covercoat composition in an amount of less than or equal to about 3 wt %, and more preferably less than or equal to about 2 wt %, based on the total weight of the curable covercoat composition.

Solvents may optionally be used in the curable covercoat compositions in order to improve the solubility of the various components in one another, increase shelf life, and/or improve ease of applicability. Many commonly used solvents may be used in the covercoat compositions such as water, toluene, acetone, dimethylformamide, dimethylacetamide, methyl ethyl ketone, 2- methoxyethyl ether (diglyme), ethylene glycol monomethyl ether, propylene glycol monomethyl ether, methoxy butanol, ethoxy butanol, methoxy propanol, ethoxy propanol, methyl cellosolve acetate, ethyl cellosolve acetate, propylene glycol monomethyl ether acetate, dipropylene glycol monomethyl ether acetate dibasic esters, propylene carbonate, gamma-butyrolactone, and the like. Combinations of solvents may also be used. A preferred solvent is dimethylacetamide. A solvent, if present, may be used in curable covercoat composition in an amount of greater than or equal to about 1 wt %, preferably greater than or equal to about 2 wt %, and more preferably greater than or equal to about 3 wt %, based on the total weight of the curable covercoat composition. The solvent may also be present in the curable covercoat composition in an amount of less than or equal to about 50 wt %, preferably less than or equal to about 30 wt %, and more preferably less than or equal to about 20 wt %, based on the total weight of the curable covercoat composition.

Detackifying agents are also optional and may be added to the curable covercoat composition in order to produce a tack free surface after the evaporation of water and solvent. Detackifying agents may be either water soluble or water insoluble monomers, oligomers, or polymers, and may generally be added to reduce photoresist exposure time to UV light during curing and to increase the cross-link density. The detackifying agents can improve the solubility of the non-polymerized portions of the covercoat and improve the toughness and cross link density of the photo-polymerized portion of the cured covercoat. Suitable detackifying monomers may be mono, di, and tri-functional acrylates and methacrylates. Suitable examples of water soluble monomers are polyethylene glycol diacrylate available, as SR 344® from Sartomer Company, and highly alkoxylated triacrylate, available as SR 9035® from Sartomer Company. A suitable example of a water insoluble acrylate monomer is 2-methoxyethyl acrylate, available as SR 244® from Sartomer. A suitable example of a water insoluble tri-functional acrylate monomer is pentaerithritol tetraacrylate commercially available as SR 295® from Sartomer. A suitable detackifying polymer is a styrene/maleic anhydride copolymer commercially available as SCRIPSET 550® from Monsanto, synthesized from a 1:1 ratio of styrene and maleic anhydride monomer and having a molecular weight of approximately about 105,000 grams/mole.

A detackifying agent, if present, may be used in the curable covercoat composition in an amount of greater than or equal to about 1 wt %, preferably greater than or equal to about 5 wt %, and more preferably greater than or equal to about 10 wt %, based on the total weight of the curable covercoat composition. The detackifying agent may also be present in the curable covercoat composition in an amount of less than or equal to about 50 wt %, preferably less than or equal to about 40 wt %, and more preferably less than or equal to about 30 wt %, based on the total weight of the curable covercoat composition.

The curable covercoat composition may further optionally comprise one or more fillers, including low-aspect ratio fillers, fibrous fillers, and polymeric fillers, for example. Examples of such fillers well known to the art include those described in “Plastic Additives Handbook, 4th Edition” R. Gachter and H. Muller (eds.), P. P. Klemchuck (assoc. ed.) Hansen Publishers, New York 1993. Non-limiting examples of fillers include silica powder such as fused silica, fumed silica, crystalline silica, natural silica sand, and various silane-coated silicas; boron-nitride powder and borosilicate powders; aluminum oxide and magnesium oxide; wollastonite including surface-treated wollastonite; calcium sulfate (as, for example, its anhydride, dihydrate or trihydrate); calcium carbonates including chalk, limestone, marble and synthetic, precipitated calcium carbonates, generally in the form of a ground particulate which often comprises 98+% CaCO₃ with the remainder being other inorganics such as magnesium carbonate, iron oxide and aluminosilicates; surface-treated calcium carbonates; talc, including fibrous, modular, needle shaped, and lamellar talcs; glass spheres, both hollow and solid, and surface-treated glass spheres typically having coupling agents such as silane coupling agents and/or containing a conductive coating; kaolin, including hard, soft, calcined kaolin, and kaolin comprising various coatings; mica, including metallized mica and mica surface treated with aminosilanes or acryloylsilanes; feldspar and nepheline syenite; silicate spheres; cenospheres; aluminosilicate (armospheres), including silanized and metallized aluminosilicate; quartz; quartzite; perlite; diatomaceous earth; silicon carbide; molybdenum sulfide; zinc sulfide; aluminum silicate (mullite); synthetic calcium silicate; zirconium silicate; barium titanate; barium ferrite; barium sulfate; flaked fillers and reinforcements such as glass flakes, flaked silicon carbide, aluminum diboride; processed mineral fibers such as those derived from blends comprising at least one of aluminum silicates, aluminum oxides, magnesium oxides, and calcium sulfate hemihydrate and combinations comprising at least one of the foregoing fillers. The most preferred fillers are fumed silicas such as Aerosil 974 from Degussa Corporation and relatively soft inorganic particulate fillers such as barium sulfate

When fillers are incorporated into the curable covercoat composition, it is preferable to use particulate fillers having an average particle size greater than or equal to about 0.001 micrometers (μm), preferably greater than or equal to about 0.01 μm, and most preferably greater than or equal to about 0.1 μm. It is also preferable to use particulate fillers having average particulate sizes less than or equal to about 50 μm, preferably less than or equal to about 30 μm, and more less than or equal to about 20 μm in the curable covercoat composition. Fillers, if present, may be used in the curable covercoat composition in an amount of greater than or equal to about 0.01 wt %, preferably greater than or equal to about 0.02 wt %, and more preferably greater than or equal to about 0.05 wt %, based on the total weight of the curable covercoat composition. The filler is generally present in the curable covercoat composition in an amount of less than or equal to about 40 wt %, preferably less than or equal to about 30wt %, and more preferably less than or equal to about 20 wt %, based on the total weight of the curable covercoat composition. If fillers are used in the composition, sufficient milling in a 3-roll mill or equivalent equipment may be used to reduce the maximum particle size to less than about 5 micrometers.

The curable covercoat composition may comprise a two-part system, one part of which is generally labeled a base or base composition, while the other is generally labeled a hardener or hardener composition. The base and the hardener are typically made separately. Respective ingredients for the base and the hardener are generally mixed with a high-speed intensive mixer. The base preferably comprises the esterified styrene maleic anhydride oligomer and the photoinitiator composition. Other components that may be added to the base include one or more of pigments, fillers, viscosity modifiers, air release agents, leveling agents, solvents, and combinations comprising one or more of the foregoing additives. The hardener preferably comprises the curing agent, catalysts, fillers, viscosity modifiers, solvents, detackifying agents, and combinations comprising one or more of the foregoing additives. If fillers are utilized in the curable covercoat composition, additional dispersion and grinding to reduce the maximum particle may be carried out and this may be accomplished using a three-roll mill or equivalent equipment. The base and the hardener are generally packaged separately in order to insure long shelf life. The base and the hardener may be mixed in different ratios depending upon the desired application and the properties desired for that application. It is generally desirable to mix the base to hardener in a ratio of about 20:80, preferably about 50:50, and most preferably about 70:30.

In one embodiment, in one manner of proceeding, the curable covercoat composition comprising the esterified styrene maleic anhydride oligomer, photoinitiator composition and the curing agent is applied to the surface of an object to be printed, such as a circuit board. The curable covercoat composition may be applied by screen printing, spraying, roller coating or other suitable methods. After applying the curable covercoat composition, the object may be placed in an oven to evaporate any solvent. Suitable conditions for flammable solvent removal are, for example, incubation to about 80° C. for about 30 to about 60 minutes. After removal from the oven, the object is cooled, following which a patterned mask is placed on top of the dried coating. The object with the covercoating is then exposed to the radiation from a UV lamp for a length of time suitable to crosslink the areas of the object not covered by the mask. UV sources such as those typically used in the printed circuit industry to cure soldermasks and photoresists such as mercury vapor lamps or metal halide lamps may be used. A suitable amount of energy, for example, is about 75 milliJoules/cm² to about 250 milliJoules/cm².

After the mask is removed, the object is contacted (i.e., sprayed) with a developer solution, for example a sodium carbonate developer solution to develop the pattern imposed on the object. A suitable developer is 1% sodium carbonate. The areas of the coating exposed to the UV radiation are insoluble in the developer solution due to the crosslinking and form a cured covercoat. The areas that were protected by the mask remain soluble and are removed by the developer solution. Following rinsing with water and drying, the object with the patterned cured covercoat is baked in an oven to thermally cure the coating and develop final properties.

The cured covercoat as described above has a number of advantageous properties over similar commercial products. The cured covercoat has an elongation at break of greater than or equal to about 10%, preferably greater than or equal to about 20%, and more preferably greater than or equal to about 30%. In addition, the cured covercoat composition displays reduced shrinkage during cure and improved flatness. In one embodiment, the variation in flatness is less than or equal to about 500 micrometers, preferably less than or equal to about 50 micrometers, and more preferably less than or equal to about 0.25 micrometers over a distance of 200 millimeters, when applied to a flat surface and allowed to dry and settle under ambient conditions for a time period of greater than 48 hours. The cured covercoat composition also displays greater photosensitivity at equivalent photo-initiator concentrations when compared with competitive products. This may be because the styrene maleic anhydride oligomers are more transparent to UV wavelengths than other resins, which permits the crosslinking reaction to occur more efficiently using less UV energy. Preferably, the energy utilized to achieve curing is greater than or equal to about 75 milliJoules/cm², preferably greater than or equal to about 80 milliJoules/cm², and more preferably greater than or equal to about 100 milliJoules/cm² of energy. Preferably the energy utilized to achieve curing is less than or equal to about 250 milliJoules/cm², more preferably less than or equal to about 225 milliJoules/cm², and most preferably less than or equal to about 200 milliJoules/cm².

The curable covercoat composition may therefore be used in a number of commercial applications such as printed circuit boards, which may be rigid or flexible. This composition provides a tack free surface, a substantially smooth, void free coating on metals such as copper and after photo-polymerization is able to withstand plating and etching solutions. The various embodiments of this disclosure are further detailed by the following examples.

### EXAMPLE 1

Curable covercoat compositions suitable for application by spraying, roll coating, slot-die coating where viscosity is desired to be low (i.e., about 500 centipoise to about 3000 centipoise) were made, comprising a base and a hardener as shown in Table 1 below. The weight percentages shown in Table 1 are with respect to the weight overall curable covercoat composition, including base, hardener, and solvent.

TABLE 1

| Component | Amount (wt %) |
|---|---|
| Base | |
| Esterified styrene maleic anhydride oligomer¹ | 68.7 |
| Photoinitiator Package | 1.748 |
| Pigment | 0.687 |
| Fumed silica filler | 1.37 |
| Acrylic leveling agents | 1.774 |
| Propylene glycol methyl ether acetate solvent | 3.43 |
| Hardener | |
| Alkylated melamine formaldehyde resin² | 6.87 |
| Toluene sulfonic acid | 0.687 |
| Silica filler | 1.374 |
| Dimethylacetamide solvent | 6.87 |
| Detackifying polymer | 6.87 |

¹SARBOX 405 (Sartomer), used as received
²CYMEL 300 (Cytec)

The base and hardener were mixed in different ratios as shown in Table 2. The composition was applied to a 1 mil (1/1000 inch, 25.4 micormeters) copper foil and dried in an oven for 30 minutes at a temperature of 80° C. It was then cured using UV light from a metal halide lamp source. The energy dosage was about 100 to about 200 milliJoules/cm². The material was then placed in an oven at 150° C. for 30 minutes and cured to its final properties.

The copper foil was etched out using cupric chloride/ammonium hydroxide etching solution to obtain a free covercoat film. The temperature of the etching solution was maintained at 50° C. and a pH of 8. The cured, free covercoat film was then cut into specimens having a width of 0.5 inches (12.7 millimeters). The tensile properties were measured using a Sintech 1/G tensile testing machine manufactured by MTS systems. The gauge length was 2 inches (5.08 centimeters) and test speed was 2 inches (5.08 centimeters) per minute.

TABLE 2

| | | | |
|---|---|---|---|
| Base to Hardener Ratio | 100:38 | 100:19 | 100:10 |
| Tensile Strength (psi) | 2828 | 3660 | 2718 |
| Elongation at break (%) | 6.0 | 16.9 | 20.2 |
| Elastic Modulus (psi) | 114,891 | 138,222 | 86,527 |

### EXAMPLE 2

A curable covercoat composition suitable for application by screen-printing where viscosity is desired to be high (i.e., about 100 poise to about 500 poise) was made, comprising a base and a hardener as shown in Table 3 below. The weight percentages shown in Table 3 are with respect to the overall weight of the curable covercoat composition, including base, hardener, and solvent.

TABLE 3

| Component | Amount (wt %) |
|---|---|
| Base | |
| Esterified styrene maleic anhydride oligomer¹ | 32.58 |
| Esterified styrene maleic anhydride oligomer² | 8.15 |
| Photoinitiator Package | 1.10 |
| Pigment | 0.31 |
| Fumed silica filler | 2.61 |
| Leveling agents | 0.87 |
| Solvent | 13.23 |
| Barium sulfate filler | 5.68 |
| Hardener | |
| Bisphenol A epoxy resin³ | 16.23 |
| Urethane acrylate oligomer⁴ | 3.25 |
| Barium sulfate filler | 4.87 |
| Silica filler | 0.46 |
| Solvent | 10.67 |

¹SARBOX 405 (Sartomer), used as received
²SARBOX 404 (Sartomer), used as received
³DER 661 (Dow Chemical)
⁴CN966J75 (Sartomer)

The coating of this example has the necessary rheology to allow it to be easily applied by screen-printing. The viscosity of the base, the hardener, and the mixture are approximately 135 poise, 420 poise, and 200 poise, respectively.

The disclosed curable covercoat compositions may have viscosities suitable for various application processes including spraying, roll coating, slot-die coating, and screen printing. Another advantage is that because of the relative transparency of the oligomers at the wavelengths used to activate the photoinitiator, the oligomers do not absorb a significant portion of the applied UV radiation. Thus, the curing reaction is more efficient. Because less UV energy is required for curing, a lower dosage of UV radiation may be used. In a practical sense, the lower amount of UV radiation means that production of the coatings can proceed at a faster rate. Faster coating is a significant advantage for the customer. An additional advantage is that the disclosed curable covercoat compositions are less expensive than many comparable commercially available products.

The cured coatings exhibit improved flexibility and mechanical properties compared to similar coatings as measured by tensile strength, elongation at break, and elastic modulus. The various properties may be adjusted, for example, by adjusting the ratio of the base to the hardener in a two-part composition. The improved flexibility and reduced shrinkage of the cured coatings are a significant advantage over prior covercoats.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A curable covercoat composition comprising, based on the total weight of the curable covercoat composition:
about 5 to about 95 weight % of an esterified styrene maleic anhydride oligomer, wherein the ester groups comprises an acrylate functionality, a methacrylate functionality, or both;
about 0.02 weight % to about 16 weight % of a photoinitiator composition; and
about 1 weight %to about 50 weight % of a curing agent.

2. The curable covercoat composition of claim 1, wherein the esterified styrene maleic anhydride oligomer has the structure 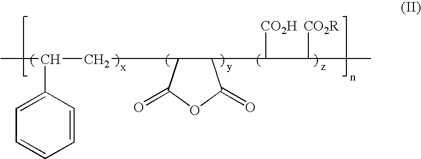
wherein
n is about 2 to about 20;
x is about 1 to about 4;
the molar ratio of x:(y+z) is about 4:1 to about 1:4;
y is about 0.1 to about 0.9, z is about 0.1 to about 0.9, wherein (y+z) is 1; and
R is a moiety containing an acrylate functionality, a methacrylate functionality, or both.

3. The curable covercoat composition of claim 1, wherein the esterified styrene maleic anhydride oligomer has a molecular weight of about 1,000 grams/mole to about 13,000 grams/mole.

4. The curable covercoat composition of claim 1, wherein the esterified styrene maleic anhydride is present in an amount of about 10 weight % to about 90 weight %, based on the total weight of the curable covercoat composition.

5. The curable covercoat composition of claim 1, wherein the photoinitiator composition is present in an amount of about 0.1 weight % to about 10 weight %, based on the total weight of the curable covercoat composition.

6. The curable covercoat composition of claim 1, wherein the curing agent is a melamine compound, a, a bisphenol A compound,, a glycoluril compound, a diamine compound, a triazene compound, a benzoguanamine compound, an oxazoline compound, or a combination comprising at least one of the foregoing curing agents.

7. The curable covercoat composition of claim 1, wherein the curing agent is an alkylated melamine formaldehyde resin.

8. The curable covercoat composition of claim 1, wherein the curing agent is a glycoluril curing agent having the structure

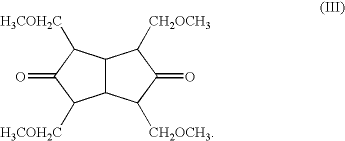

9. The curable covercoat composition of claim 1, wherein the curing agent is present in an amount of about 3 weight %to about 20 weight %, based on the total weight of the curable covercoat composition.

10. The curable covercoat composition of claim 1, further comprising, based on the total weight of the curable covercoat composition, up to about 50 weight % of a solvent, up to about 50 weight % of a detackifying agent, and up to about 20 weight % of a filler, or a combination comprising one or more of the foregoing additives.

11. The curable covercoat composition of embodiment 1, wherein the curable covercoat composition, when cured using UV light, produces a cured covercoat having an elongation to break of greater than about 10%.

12. The curable covercoat composition of claim 1, wherein the curable covercoat composition is a two-part composition comprising a base composition and a hardener composition, wherein the base composition comprises the esterified styrene maleic anhydride oligomer and the photoinitiator composition, and the hardener composition comprises the curing agent.

13. The curable covercoat composition of claim 12, wherein the base composition further comprises a pigment, a filler, a viscosity modifier, an air release agent, a leveling agent, a solvent, or a combination of one or more of the foregoing additives.

14. The curable covercoat composition of claim 12, wherein the hardener composition further comprises a catalyst, a filler, a viscosity modifier, a solvent, a detackifying agent, or a combination of one or more of the foregoing additives.

15. A method of forming a cured covercoat comprising:
coating an object with a curable covercoat composition comprising
an esterified styrene maleic anhydride oligomer,
a photoinitiator composition, and
a curing agent to form a film; and
curing the film using a source of radiation.

16. The method of claim 15, further comprising:
placing a mask on the film prior to curing the film and protecting portions of the film from the source of radiation; and
contacting the film with a developer solution after curing the film to produce a patterned cured covercoat.

17. The method of claim 15, wherein the source of radiation is UV radiation.

18. An article manufactured from the composition of claim 1.

19. An article manufactured by the method of claim 15.
